(19) United States
(12) Patent Application Publication
(10) Pub. No.: US 2014/0350984 A1
(43) Pub. Date: Nov. 27, 2014

(54) PROJECT MANAGEMENT SYSTEM AND METHOD

(71) Applicant: General Electric Company, Schenectady, NY (US)

(72) Inventors: AARON RICHARD MITTI, JACKSONVILLE, FL (US); MARTIN PAGET, JACKSONVILLE, FL (US); CHRISTIAN ZAMBRANO, JACKSONVILLE, FL (US); TRAVIS HAMPTON, JACKSONVILLE, FL (US)

(73) Assignee: General Electric Company, Schenectady, NY (US)

(21) Appl. No.: 14/220,198

(22) Filed: Mar. 20, 2014

Related U.S. Application Data
(60) Provisional application No. 61/826,144, filed on May 22, 2013.

(51) Int. Cl. G06Q 10/06

(52) U.S. Cl. CPC G06Q 10/063118
USPC 705/7.17

(57) ABSTRACT

Systems and methods of the invention relate to creating a schedule to assign one or more workers to a project on one or more dates based on project information and/or worker information. Resource data (e.g., workers, equipment, tools, among others) and project data (e.g., location, type, cost, client, lead time, parts needed, among others) can be evaluated by an aggregation component in which a manager component can create a schedule that includes at least one worker and an assignment to the project based on the evaluation of the resource data and/or the worker information.

### CROSS-REFERENCE TO RELATED APPLICATIONS

This application claims the benefit of U.S. Provisional Application Ser. No. 61/826,144, filed May 22, 2013, and entitled “PROJECT MANAGEMENT SYSTEM AND METHOD.” The entirety of the aforementioned application is incorporated herein by reference.

### BACKGROUND

1. Technical Field

Embodiments of the subject matter disclosed herein relate to a resource assignment system and management thereof.

2. Discussion of Art

Schedules provide coordination between multiple workers for one or more projects. Schedules can include varying amounts of information and detail. For instance, a stream-lined schedule can include time slots and employee assignment for each particular task to work toward completion of the project. Organizing and coordinating a schedule to complete a project often includes human guesswork of complex interdependencies that can lead to ineffective schedules and deficiencies for not accounting for particular factors or data.

It may be desirable to have a system and method that differs from those systems and methods that are currently available.

### BRIEF DESCRIPTION

In an embodiment, a method is provided that includes identifying a project that includes at least one of a build, a test, or a cut-over, among others (e.g., surveys, preliminary engineering, design work, supply chain/material ordering/logistics, delivery, maintenance, retirement from use, and the like), and the project is associated with at least one of a client asset, a structure, a vehicle, a part, or a system (e.g., combination of items, interlocking made up of signals, switches, and control equipment, among others). The method includes ascertaining an estimated amount of time to complete the project by evaluating one or more workers to ascertain an availability of each worker to participate on a completion of the project. The method includes generating a list of a crew that includes the one or more eligible workers and a schedule for each of the one or more workers to participate to complete a project based on the estimated amount of time. In an embodiment, the workers can be assigned to one or more projects and resource assignment optimization between projects can be accounted.

In an embodiment, a system is provided that includes a first component configured to evaluate a project to ascertain a number of workers to assign, one or more parts for the project, and a completion date. The system includes a second component configured to create a schedule for the project, and the schedule assigns one or more workers to the project for one or more dates based on the number of workers to assign and the completion date.

In an embodiment, a system is provided that includes means for identifying a project that includes at least one of a build, a test, or a cut-over, among others (e.g., surveys, preliminary engineering, design work, supply chain/material ordering/logistics, delivery, maintenance, retirement from use, and the like), and the project is associated with at least one of a client asset, a structure, a vehicle, a part, or a components of the system (e.g., combination of items, interlocking made up of signals, switches, control equipment, among others). The system includes means for ascertaining an estimated amount of time to complete the project and means for evaluating one or more workers to ascertain an availability of each worker to participate on a completion of the project. The system includes means for generating a list of a crew that includes the one or more workers and a schedule for each of the one or more workers to participate to complete the project based on the estimated amount of time.

### BRIEF DESCRIPTION OF THE DRAWINGS

Reference is made to the accompanying drawings in which particular embodiments and further benefits of the invention are illustrated as described in more detail in the description below, in which:

FIG. 1 is an illustration of an embodiment of a system for creating a schedule for one or more workers to participate on completing a project based on information related to the project and/or each worker;

FIG. 2 is an illustration of an embodiment of a system for adjusting a generated schedule based on real-time collected information;

FIG. 3 is an illustration of an embodiment of a system for ascertaining a number of parts or a number of workers for a project;

FIG. 4 is an illustration of an embodiment of a system for generating a schedule based on user input for a project simulation; and

FIG. 5 illustrates a flow chart of an embodiment of a method for creating a schedule for one or more workers to participate on completing a project based on information related to the project and/or each worker.

### DETAILED DESCRIPTION

Embodiments of the invention relate to methods and systems for creating a schedule to assign one or more workers to a project on one or more dates based on project information and/or worker information. Resource data (e.g., workers, equipment, tools, among others), other data (e.g., union districts, union rules, time off, vacation time, sick time, holidays, blackout dates, blackout dates due to other work on location, seasonal issues, weather conditions, operations demands for location access, capabilities of resources, efficiencies of resources, skill factors, testing resources, and the like), and project data (e.g., location, type, cost, client, lead time, parts needed, among others) can be evaluated by an aggregation in which a manager component can create a schedule that includes at least one worker and an assignment to the project based on the evaluation of the resource data and/or the worker information. By evaluating various factors associated with the one or more works and the project via the worker information and the project data respectively, the manager component generates a schedule accounting for data uncounted for in conventional techniques.

With reference to the drawings, like reference numerals designate identical or corresponding parts throughout the several views. However, the inclusion of like elements in different views does not mean a given embodiment necessarily includes such elements or that all embodiments of the invention include such elements.

The term “component” or “engine” as used herein can be defined as a portion of hardware, a portion of software, or a combination thereof A portion of hardware can include at least a processor and a portion of memory, wherein the memory includes an instruction to execute. The term “cut-over” as used herein can be defined as a period of time in which a testing phase for a project ends and a regular use period for the project begins. The term “build” as used herein can be defined as a period of time in which a construction phase for a project begins and a testing period begins for the project. The term “test” as used herein can be defined as a period of time between a construction phase for a project and a cutover phase of the project. The term “client asset” as used herein can be defined as a fixed asset (e.g., structure, portion of software, portion of hardware, and the like) or a mobile asset (e.g., vehicle, and the like) that is owned and/or operated by a client entity such as, for example, a railroad, a power generation company, a shipping company (e.g., land, sea, air, and/or an combination thereof), a mining equipment company, an airline, or another asset-owning and/or asset-operating entity. The term “structure” as used herein can be defined as a man-made structure or a machine such as, for example, a building, a crane, or a bridge, among others. The structure can be inspected in order to ensure integrity for one or more parts that comprise the man-made structure or the machine. The term “vehicle” as used herein can be defined as an asset that is a mobile machine that transports at least one of a person, people, or a cargo. For instance, a vehicle can be, but is not limited to being, a rail car, an intermodal container, a locomotive, a marine vessel, mining equipment, a stationary power generation equipment, industrial equipment, construction equipment, and the like. The term “part” as used herein can be defined as a portion of a client asset, a portion of a structure, and/or a portion of a vehicle, wherein the “part” is involved in a repair, construction, testing, or maintenance related to at least one of the client asset, the structure, or the vehicle. The term “ownership” as used herein can be defined as proof of legal claim to property such as a vehicle, a structure, a client asset, and the like. The proof can be a title, a lease agreement, a contract, a legal document, a purchase agreement, among others. The term “project” as used herein can be defined as a job that a portion of a resource is assigned to at least one of build, test, cut-over, maintain, service, deconstruct, or a combination thereof The resource can be, for instance, a part, a client asset, a structure, a vehicle, and the like. The term “crew” as used herein can be defined as one or more workers that participate on a project.

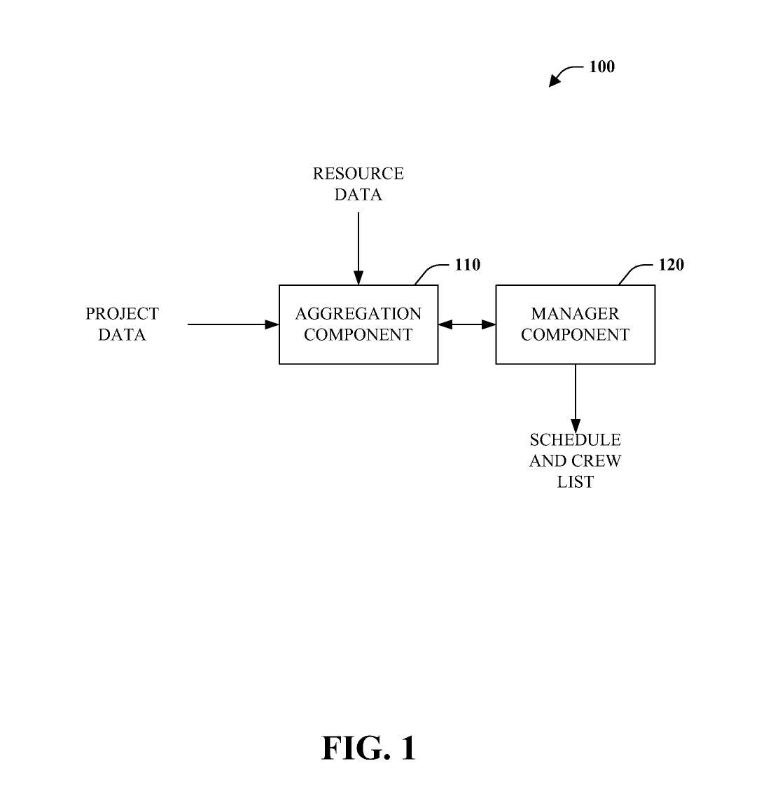

FIG. 1 is an illustration of a system 100 for creating a schedule for one or more workers to participate on completing a project based on information related to the project and/or each worker. The system includes an aggregation component 110 that is configured to collect and/or receive at least one of a portion of project data or a portion of resource data. A manager component 120 is configured to create a schedule based on the portion of project data or the portion of resource data. The schedule can include an assignment of one or more workers to a project on a particular date or time in light of an evaluation of the portion of project data or the portion of resource data (e.g., via the aggregation component). A list of workers (e.g., also referred to as a crew list) and respective assignment dates and/or times can also be created by the manager component based on the evaluation of the portion of project data and/or the portion of resource data. In an embodiment, the manager component can receive or calculate an estimated amount of time to complete the project that can be used to generate the schedule. For example, the estimated amount of time can be pre-defined (e.g., manually set), based upon a previous project (e.g., comparison to historic data related to projects), or determined based on evaluation of tasks (e.g., a project can include a set of tasks), parts, equipment, type of project, among others. In an embodiment, the system can evaluate a first project and a disparate project (e.g., a different or other project, such as a different or other project that is unrelated to the first project except to the extent that first project and the disparate project may receive resources from a common source, such as a common pool of workers) to generate a schedule. For instance, the disparate project can be a project that has been completed, an ongoing project (e.g., not completed), and the like. The system can leverage historical data of other projects to schedule a project to improve scheduling in light of previous situations, data, criteria, and the like.

By way of example and not limitation, the portion of project data can be data associated with the project such as, but not limited to, a geographic location of the project, a priority of the project, a cost of the project, a dispatch requirement of the project, a resource lead time for the project, a part related to the project, a shipment of a part for the project, and the like. For example, the portion of resource data can be, but is not limited to being, data associated with a resource for a project such as a worker, an employee, a contractor, equipment, tools, a part, among others. In an embodiment, the portion of resource data can relate to employee information, wherein the employee information relates to at least one of a shift schedule of the employee, a union requirement, an expertise of the employee, a geographic location of the employee, a suspension for the employee, a vacation time of the employee, an hourly rate of the employee, an experience on a previous project, and the like.

For instance, a group of employees that are available at a time (e.g., available in that the employees are not assigned to a project at the time) can be evaluated for a project in which a subset of the employees can be assigned to the project in light of available working hours, hourly rates, skill sets, geographic proximity, type of project, among others. The schedule created can include an appropriate amount of workers to complete the project within a desired time frame. For instance, if the time frame is shortened, the system can increase at least one of a number of workers assigned to the project, the number of hours assigned to one or more workers, the number of hours to work each date, the days to work for each worker, among others.

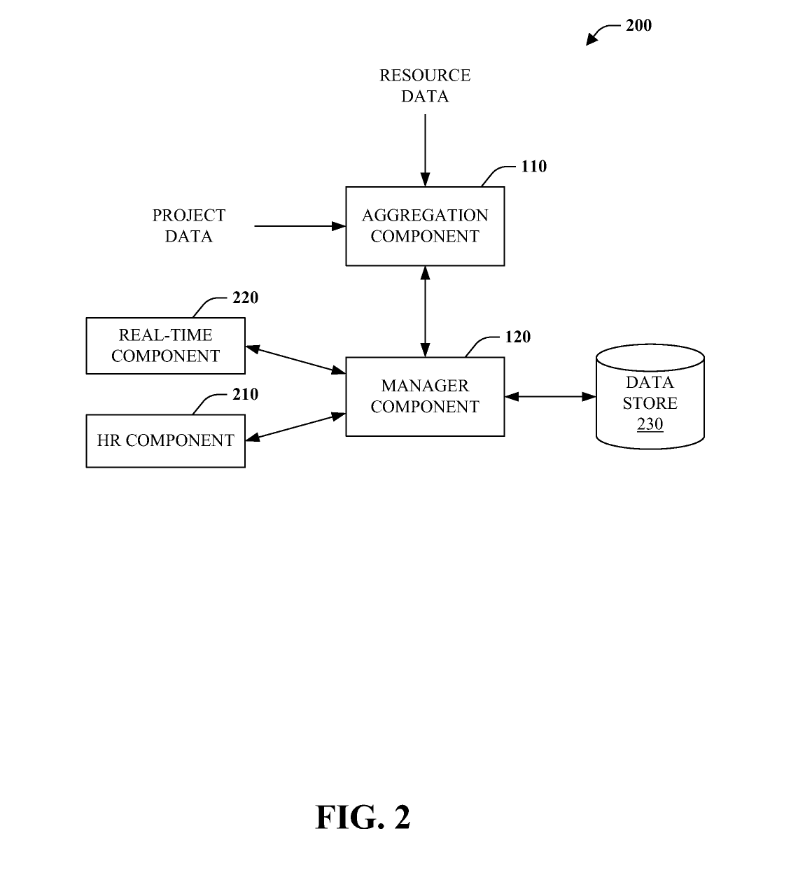

FIG. 2 is an illustration of a system 200 for adjusting a generated schedule based on real-time collected information. The aggregation component can evaluate a portion of project data and/or a portion of resource data to identify factors associated with a worker (e.g., that may work on one or more projects) or a project (e.g., that is to be completed and workers are to be assigned). The manager component can create a schedule for a period of time (e.g., a duration of time to complete the project or a portion of the project such as a task) that assigns available workers for dates to complete the project or task within the period of time. The manager component and/or the aggregation component can consider numerous factors related to the project and/or the workers (referenced above).

The system includes a Human Resources (HR) component 210 (herein referred to as “HR component.”). The HR component is configured to identify a pool of workers available to assign to a project based on an additional need for the project. For instance, a project may have a timeline shortened to complete sooner and additional workers may be needed. In light of this need, the HR component can identify or contact potential workers for the project (e.g., workers with a skill set particular for the project, newly available workers, among others). The HR component leverages one or more workers outside a set of workers evaluated with resource data based on the set being used and evaluated already. For example, resource data can be related to a set of workers (e.g., employed, contracted, independent contractor, among others) and the schedule can use a subset of the set of workers. In light of a change to the schedule or the project, more workers can be identified from an additional set of workers (e.g., stand-by workers, part-time employees, among others).

The system includes a real-time component 220 that is configured to adjust the generated schedule in real-time, wherein the adjustment can relate to an assigned date, an assigned employee, a start date of the project, a projected end date of the project (e.g., handle projects running late or behind schedule to affect downstream projects or portions of projects), an end date of the project, among others. The real-time component receives or aggregates information related to changes or adjustments in real-time and/or with minimal delay. By way of example and not limitation, the changes or adjustments can relate to an addition or subtraction of a worker on a project (e.g., hired worker for the project, worker leaves sick, worker calls in sick, worker termination, among others), the start or end date, a delivery of a part for the project, weather, among others.

In an embodiment, the real-time component can generate an update in response to a change in status of an input value (e.g., information related to changes or adjustments, resource data, project data, and the like). For instance, if an employee already assigned to a crew becomes unavailable (certification lapses, gets ill, etc.), the real-time component can generate an updated crew list via an electronic communication to the real-time component, component, and/or controller/microprocessor incorporated with the system. In another embodiment, the update can be a “push” update that is directly communicated to a device, system, component, controller, and/or microprocessor.

For example, a weather condition that affects a project (e.g., weather condition limits work to be performed, etc.) can be accounted for by the real-time component by adjusting the schedule such that one or more workers can be rescheduled to a date with more favorable weather to perform work. In such example, the weather condition or weather alert can be received and the real-time component can generate a modified schedule and/or a notification indicating that the assigned one or more workers on the project can stop work on the project for that time and be rescheduled at a different time when the weather is more suitable to perform work on the project.

In another example, a worker assigned to a project can call in sick or call off work or leave work early. The real-time component can modify the schedule and assigned workers on a project in light of such changes. In such example, the real-time component can request additional worker(s) (e.g., via the HR component) or increase a scheduled work time for the remaining workers on the project. For instance, the real-time component can receive indicators that can trigger an adjustment or modification to the schedule, assigned workers, the dates and/or times the workers are to work on the project, or the timeline (e.g., start date, end date, date of completion, etc.) of the project. In another example, a due date for completion of the project can be moved to a later date in which the real-time component can trigger the manager component to update the schedule to reduce the amount of workers on the project and/or reduce the amount of time the workers are to work on the project. In such example, the manager component can further use the extra workers (e.g., extra based on the due date moved to a later time) or the extra amount of time of the workers on another project.

In an embodiment, the real-time component can communicate with a time clock for one or more workers with a project. For instance, each employee can clock in and clock out which allows monitoring of work hours for particular portions of a project to facilitate tracking progress. In another embodiment, the real-time component can be accessed by a supervisor, a manager, or a user managing one or more workers on the project to input and/or communicate a change or update to the schedule, the project, or one or more workers.

In an embodiment, the aggregation component and/or the manager component or other discussed components or elements (e.g., real-time component, HR component, scenario engine, part predict component, labor predict component, among others) stores information related to the systems 100, 200, 300, and/or 400 (and/or method 500) with a data store 230. The data store can include information such as, but not limited to, project data, resource data, estimated amount of time to complete a project, project completion time, cost data (e.g., part cost, project cost, employee cost, worker cost, among others), part ordering data, delivery data, equipment data, among others, and/or a suitable combination thereof

It is to be appreciated that the data store can be, for example, either volatile memory or nonvolatile memory, or can include both volatile and nonvolatile memory. The data store of the subject systems and methods is intended to comprise, without being limited to, these and other suitable types of memory. In addition, it is to be appreciated that the data store can be a server, a database, a hard drive, a flash drive, an external hard drive, a portable hard drive, a cloud-based storage, and the like. The data store can be a stand-alone component (as depicted), incorporated into the manager component, incorporated into the aggregation component, or a combination thereof

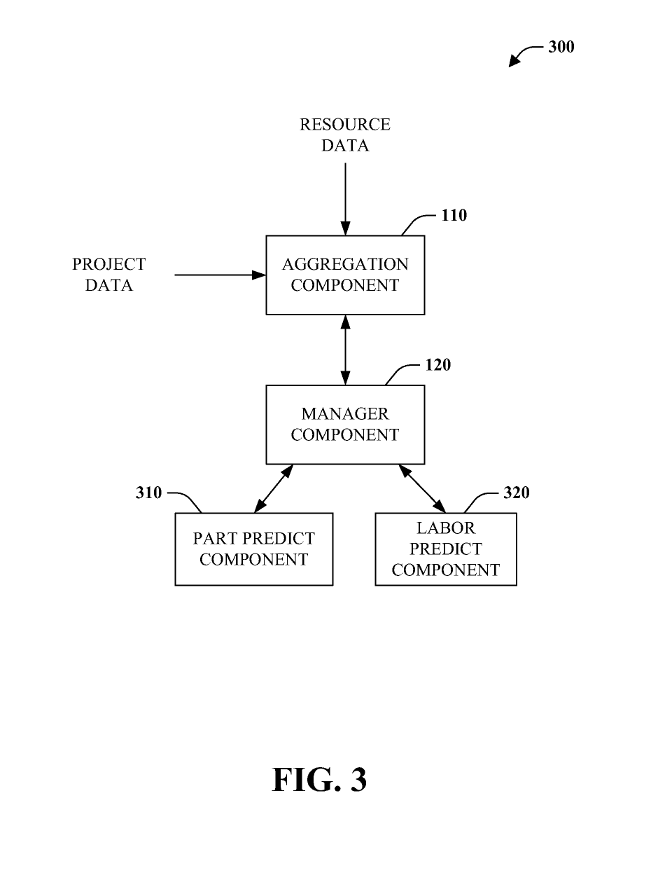

FIG. 3 is an illustration of a system 300 for ascertaining a number of parts or a number of workers for a project. The system includes a part predict component 310 that is configured to manage an inventory of parts based on one or more projects. The part predict component leverages the portion of project data and/or a portion of resource data to identify a part utilized with the project and whether the part or quantity of parts are available at a time for the project, wherein the time is a date or time the part is needed to perform work on the project. The part predict component can be a stand-alone component (as depicted), incorporated into the manager component, incorporated into the aggregation component, incorporated into the labor predict component, or a combination thereof

For instance, the part predict component can order one or more parts based on a generated schedule and/or a part used for a portion of the project scheduled. In an embodiment, the part predict component can automatically manage an inventory of parts for one or more projects in which purchases or re-supplying of one or more parts can be based upon a use in a project, a time of the project (e.g., a start time, an end time, a due date of the project), a priority of the project, a depletion of a part inventory, a portion of a project to be completed, a delivery date of a part, a delivery time of a part, and the like.

In an embodiment, the part predict component can be leveraged by the manager component to facilitate creating the schedule. For instance, the part predict component can generate a part(s) list in which an estimated delivery time (e.g., shipping time, order time, ship to site time, ship to project location time, among others, including consideration of supply chain and storage requirements and limitations) can be provided, wherein the manager component can factor the estimated delivery time into the created schedule (e.g., target due date, start date, end date, projected date, start date for a portion of a project, among others).

The system includes a labor predict component 320 that is configured to estimate at least one of a number of workers for a project or an amount of hours to perform for a project based on the portion of project data. In an embodiment, the labor predict component can evaluate the portion of project data to indicate or adjust the number of workers to assign or schedule for a project and/or the amount of work force (e.g., man-hours, equipment use, parts, among others). For instance, a project involving a structure A can be previously performed and leveraged to identify an amount of workers or hours needed to complete. The labor predict component can utilize historical data related to projects to identify factors to generate the schedule or assign one or more workers to the project. The labor predict component can be a stand-alone component (as depicted), incorporated into the manager component, incorporated into the aggregation component, incorporated into the part predict component, or a combination thereof

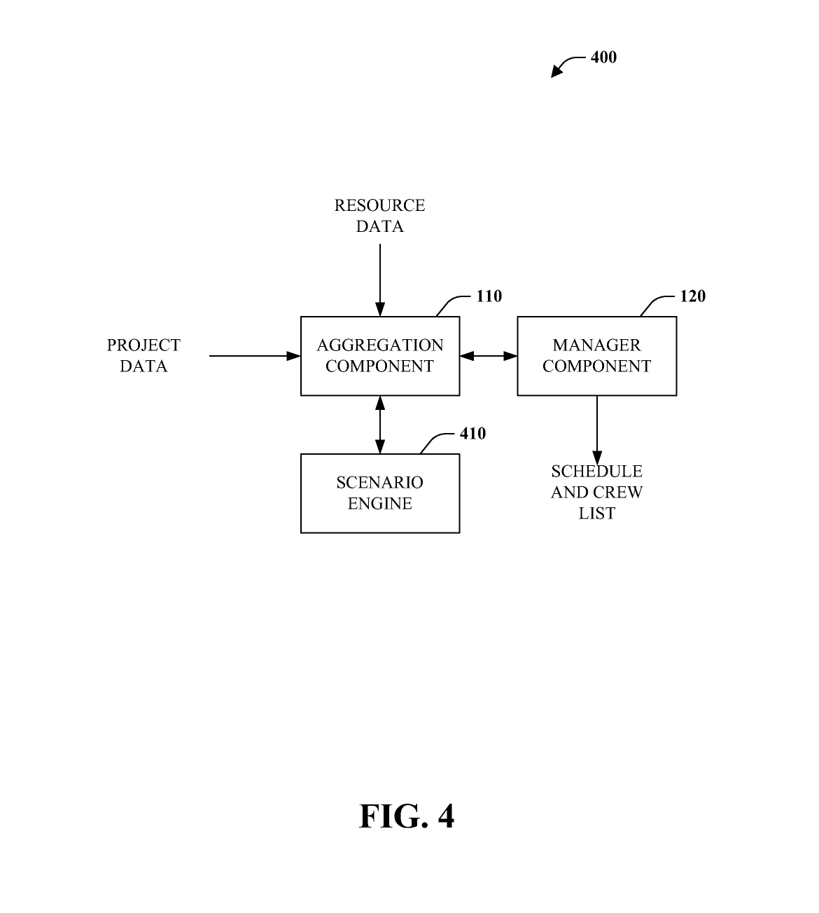

FIG. 4 is an illustration of a system 400 for generating a schedule based on user input for a project simulation. The system includes a scenario engine 410 that is configured to generate a schedule or a crew list (e.g., one or more workers assigned) to a project based on received or collected project data or resource data. In an embodiment, the scenario engine allows evaluation of situational data that is based on a real-life project, a fabricated project, or a simulated project. For instance, a user can provide a portion of project data or a portion of resource data based on a hypothetical scenario, wherein the scenario engine can generate a schedule or crew list for such scenario based on historical information based on real-life projects. The scenario engine can be a stand-alone component (as depicted), incorporated into the aggregation component, incorporated into the manager component, or a combination thereof.

In an embodiment, project data and/or resource data for each project can be collected and categorized based on details related thereto. Based on this categorization and collected data, query information (e.g., user-input related to a scenario or simulation) can be matched to substantially similar information collected and/or categorized. The scenario can be matched to previous projects or historical data to generate a schedule or crew list representative of a projected outcome for the project. In another embodiment, the use of on-going or upcoming projects, schedules, or crew lists can be employed in order to facilitate prediction of simulations or hypothetical project scenarios.

The aforementioned systems, components, (e.g., aggregation component, manager component, real-time component, part predict component, labor predict component, HR component, scenario engine, among others), and the like have been described with respect to interaction between several components and/or elements. Such devices and elements can include those elements or sub-elements specified therein, some of the specified elements or sub-elements, and/or additional elements. Further yet, one or more elements and/or sub-elements may be combined into a single component to provide aggregate functionality. The elements may also interact with one or more other elements not specifically described herein.

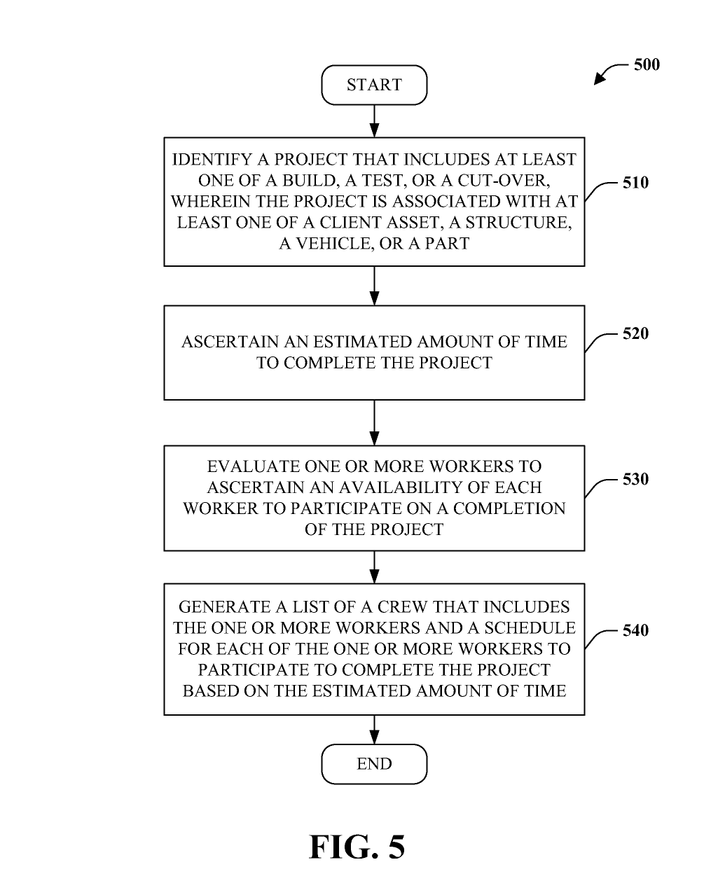

In view of the exemplary devices and elements described supra, methodologies that may be implemented in accordance with the disclosed subject matter are described with reference to the flow chart of FIG. 5. The methodologies are shown and described as a series of blocks, the claimed subject matter is not limited by the order of the blocks, as some blocks may occur in different orders and/or concurrently with other blocks from what is depicted and described herein. Moreover, not all illustrated blocks may be required to implement the methods described hereinafter. The methodologies can be implemented by a component or a portion of a component that includes at least a processor, a memory, and an instruction non-transiently stored on the memory for the processor to execute.

FIG. 5 illustrates a flow chart of a method 500 for creating a schedule for one or more workers to participate on completing one or more projects based on information related to the project(s) and/or each worker. At reference numeral 510, a project that includes at least one of a build, a test, or a cutover can be identified, wherein the project is associated with at least one of a client asset, a structure, a vehicle, or a part. At reference numeral 520, an estimated amount of time to complete the project can be ascertained. At reference numeral 530, one or more workers can be evaluated to ascertain an availability of each worker to participate on a completion of the project. At reference numeral 540, a list of a crew can be generated that includes the one or more workers and a schedule for each of the one or more workers to participate to complete the project based on the estimated amount of time.

The method further may include evaluating weather for a geographic location of the project. The crew and the schedule may be based at least in part on the weather or a weather forecast. A portion of the employee information may be used in evaluating and assigning the crew and the schedule and may be based at least in part on the estimated amount of time and the portion of employee information. The employee information may relate to, for example, at least one of a shift schedule of the employee, a union requirement, an expertise of the employee, a geographic location of the employee, a suspension for the employee, a vacation time of the employee, an hourly rate of the employee, or an experience the employee may have from their work on a previous project. Other suitable items of employee information may include personal details, such as their vacation time, sick time, skill set, and the like.

The method may include evaluating project information and assigning the crew and respective schedule for each to participate on the project based on the estimated amount of time and the project information. The project information can relate to at least one of a geographic location of the project, a priority of the project, a cost of the project, a dispatch requirement of the project, a resource lead time for the project, a part related to the project, a shipment of a part for the project, and the like. The project information may relate to a completion time of the project, a start time of the project, an amount of time to complete the project, among others. The method may include identifying a part used to complete the project, ascertaining a delivery time of the part to a geographic location of the project, and/or assigning a portion of the crew based on the delivery time of the part.

The method may include managing an inventory of parts for projects based on the identified project, wherein the parts are at least one of ordered from a seller, shipped to a geographic location of the project, shipped from a central receiving location associated with the project, among others. The method may include assigning a crew with the schedule based on the inventory of parts for the project. The estimated amount of time can be adjusted based on the inventory of parts for the project. The schedule may include a start date for the project and a completion date for the project. The schedule or the list of the crew can be communicated to the one or more workers. The method may include receiving a query related to the estimated amount of time, the one or more workers, the availability of each worker, the project, an additional project, an additional worker, and the like. The method may also include generating an additional schedule for the project based on an evaluation of the query.

In any of the embodiments herein, one or more of the aspects of a method or system may be carried out automatically or autonomously, meaning without human operator interaction, for example, by a processor of a component executing instructions stored on a non-transitory processor-readable medium. The term non-transitory processor-readable medium comprises all computer- or other processor-readable media, with the sole exception being a transitory, propagating signal. In one embodiment, for example, a non-transitory processor-readable medium comprises instructions that when executed by a processor cause the processor to automatically estimate an amount of time to complete a project that includes at least one of a build, a test, or a cut-over (wherein the project is associated with at least one of a client asset, a structure, a vehicle, a part, or a system), automatically ascertain an availability of one or more workers to participate on the project, and automatically generate both a list of a crew that includes the one or more workers and a schedule for the one or more workers to participate on the project based at least in part on the estimated amount of time. (For example, the list and schedule may be outputted to a printer, to a display of a user interface, to a memory for storage for retrieval later to a printer or display, or the like.) In this context, although certain steps or functions are carried out automatically, this does not preclude the non-transitory processor-readable medium from including instructions, that when executed by the processor, cause the processor to initiate automatically carrying out the steps upon receipt of a user input to do so.

In the specification and claims, reference will be made to a number of terms that have the following meanings. The singular forms “a”, “an” and “the” include plural referents unless the context clearly dictates otherwise. Approximating language, as used herein throughout the specification and claims, may be applied to modify a quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value. Moreover, unless specifically stated otherwise, a use of the terms “first,” “second,” etc., do not denote an order or importance, but rather the terms “first,” “second,” etc., are used to distinguish one element from another.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances an event or capacity can be expected, while in other circumstances the event or capacity cannot occur—this distinction is captured by the terms “may” and “may be.”

This written description uses examples to disclose the invention, including the best mode, and also to enable one of ordinary skill in the art to practice the invention, including making and using a devices or systems and performing incorporated methods. The patentable scope of the invention is defined by the claims, and may include other examples that occur to one of ordinary skill in the art. Such other examples are intended to be within the scope of the claims if they have structural elements that do not differentiate from the literal language of the claims, or if they include equivalent structural elements with insubstantial differences from the literal language of the claims.

What is claimed is:

1. A method, comprising:
estimating an amount of time to complete a project that includes at least one of a build, a test, or a cut-over, wherein the project is associated with at least one of a client asset, a structure, a vehicle, a part, or a system;
ascertaining an availability of one or more workers to participate on the project; and
generating both a list of a crew that includes the one or more workers and a schedule for the one or more workers to participate on the project based at least in part on the estimated amount of time.

2. The method of claim 1, further comprising assigning the crew and the schedule based at least in part on a portion of employee information.

3. The method of claim 2, further comprising associating the employee information with at least one of a shift schedule of an employee, a union requirement, an efficiency rating of the employee, a geographic location at a defined time of the employee, a suspension status for the employee, a vacation time of the employee, an hourly rate of the employee, an expertise level of the employee, or an experience by the employee while on a previous project, wherein the employee is one of the one or more workers.

4. The method of claim 1, further comprising assigning the crew and the schedule based at least in part on weather conditions at a site of the project.

5. The method of claim 1, further comprising assigning the crew and the schedule based on a portion of project information of the project.

6. The method of claim 5, further comprising associating the project information to at least one of a geographic location or site of the project, a priority of the project, a cost of the project, a dispatch requirement of the project, a resource lead time for the project, a part related to the project, or a shipment delivery date of a part for the project.

7. The method of claim 5, wherein the project information relates to at least one of a completion time of the project, a start time of the project, or an amount of time to complete the project.

8. The method of claim 5, further comprising:
identifying a part used to complete the project;
ascertaining a delivery time of the part to a geographic location of the project; and
assigning at least a portion of the crew based on the delivery time of the part.

9. The method of claim 1, further comprising managing an inventory of one or more parts for the project, wherein the one or more parts are at least one of: ordered from a seller, shipped to a geographic location of the project, or shipped from a central receiving location associated with the project.

10. The method of claim 9, further comprising assigning a portion of the crew with the schedule based on the inventory of one or more parts for the project.

11. The method of claim 9, further comprising adjusting the estimated amount of time based on the inventory of one or more parts for the project.

12. The method of claim 1, wherein the schedule includes a start date for the project and a completion date for the project, and further comprising bounding the estimating of the time based at least in part on the start date or the completion date.

13. The method of claim 1, further comprising communicating at least one of the schedule or the list of the crew to the one or more workers, and optionally logging a response from the one or more workers that is related to the communication.

14. The method of claim 1, further comprising:
receiving a query related to at least one of the estimated amount of time, the one or more workers, the availability of each worker, the project, an additional project, or an additional worker; and
generating at least an additional schedule for the project based on an evaluation of the query.

15. A system comprising:
a first component configured to evaluate at least one of a project or a disparate project to ascertain a number of workers to assign, one or more parts for the project, and a completion date, wherein the disparate project is completed or on-going; and
a second component configured to create a schedule for the project, wherein the schedule assigns one or more workers to the project for one or more dates based on the number of workers to assign and the completion date.

16. The system of claim 15, further comprising a third component configured to at least one of the following:
identify a delivery time to a geographic location for the project; and
manage an inventory for the one or more parts of the project.

17. The system of claim 16, wherein the second component is further configured to adjust at least one of the schedule or the assignment of the one or more workers based on the delivery time.

18. The system of claim 15, wherein the second component is further configured to adjust at least one of the schedule or the assignment of the one or more workers based on a weather condition for a geographic location proximate to a location for the project.

19. The system of claim 15, wherein the second component is further configured to adjust at least one of the schedule or the assignment of the one or more workers based on at least one of a shift schedule of the employee, a union requirement, an expertise of the employee, a geographic location of the employee, a suspension for the employee, a vacation time of the employee, an hourly rate of the employee, or an experience on a previous project.

20. A system, comprising:
means for identifying a project that includes at least one of a build, a test, or a cut-over, wherein the project is associated with at least one of a client asset, a structure, a vehicle, or a part;
means for ascertaining an estimated amount of time to complete the project;
means for evaluating one or more workers to ascertain an availability of each worker to participate on a completion of the project; and
means for generating a list of a crew that includes the one or more workers and a schedule for each of the one or more workers to participate to complete the project based on the estimated amount of time.
